(19) United States
(12) Patent Application Publication
(10) Pub. No.: US 2015/0256707 A1
(43) Pub. Date: Sep. 10, 2015

(54) PHOTO MEDIA PRINTING METHOD AND PHOTO MEDIA PRINTING SYSTEM

(71) Applicant: Primax Electronics Ltd., Taipei (TW)

(72) Inventor: JUNG-CHANG YANG, Taipei (TW)

(73) Assignee: Primax Electronics Ltd., Taipei (TW)

(21) Appl. No.: 14/286,740

(22) Filed: May 23, 2014

(30) Foreign Application Priority Data
Mar. 7, 2014 (TW) 103107991

(51) Int. Cl. H04N 1/32; H04N 1/00; G06F 3/12

(52) U.S. Cl. CPC H04N 1/32325; G06F 3/1222; G06F 3/1238; G06F 3/1286; H04N 1/00461; H04N 2201/3228; H04N 2201/0082

(57) ABSTRACT

A photo media printing method includes the following steps. Firstly, a photo media file is selected by a digital media player of an area network. Then, a marked is added to the selected photo media file by the digital media player, so that a new photo media file containing the mark is produced. Afterwards, the new photo media file is transmitted to a network printing device of the area network, and the new photo media file is printed out by the network printing device. In other words, the mark is added to the photo media file by simply selecting the photo media file.

### FIELD OF THE INVENTION

The present invention relates to a photo media printing method, and more particularly to a photo media printing method for printing photo media files in an area network.

### BACKGROUND OF THE INVENTION

Generally, an area network comprises a local area network (LAN), a metropolitan area network (MAN) and a wide area network (WAN). With increasing development of science and technology, the area network further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media file 15. The media file 15 is for example an audio file, a photo file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a second storage element 121 of the digital media player 12. After the media file 15 is received by the digital media player 12, the media file 15 that is temporarily stored into the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 may be played by the digital media renderer 33.

As mentioned above, the digital media server, the digital media controller, the digital media renderer and the digital media player included in the same DLNA system may transfer or play media files through the network router. The digital media server and the digital media renderer may be referred as passive control devices that can be controlled. Moreover, the digital media controller and the digital media player may be referred as active control devices that can control the passive control devices. For example, a user in a living room may allow a smart phone to be connected to a computer host in a study room. Moreover, through the smart phone, the user may browse the audio files in the computer host and select a desired audio file from the computer host. Then, the selected audio file is transmitted from the smart phone to a stereo device in the living room. After the audio file is received by the stereo set, the audio file is played by the stereo device. Consequently, the purposes of conveniently and quickly sharing media contents can be achieved by the DLNA system.

In addition to the digital media server, the digital media controller, the digital media renderer and the digital media player, a digital media printer (DMPr) complying with the DLNA protocol is also introduced to the market. The digital media printer may acquire a photo media file from the DLNA system. After the photo media file from the DLNA system is acquired, the photo media file may be printed out by the digital media printer. With the advance of the digital media printer, it is easier to print out the photo media file that is shared in the DLNA system. However, some problems may occur. For example, the photo media file may be embezzled by other users. For preventing the photo media file from being embezzled, a mark including a specified information (e.g. the name of the sharer of the photo media file or a website address of a personal social networking website) is usually added to the shared photo media file. For example, the mark is a watermark or a stamp mark.

However, the process of adding the mark to the photo media file is troublesome to the user. A conventional process of adding the mark to the photo media file will be illustrated as follows. Firstly, the user may operate a third-party device (e.g. a computer, a smart phone or a tablet computer) to execute a specified application program to add the mark to the photo media file. Then, the photo media file with the mark is transmitted to the DLNA system. Consequently, the photo media file may be shared through the DLNA system. According to the mark contained in the photo media file, other users may recognize the source of the photo media file, so that the photo media file will not be embezzled. Moreover, after the photo media file with the mark is transmitted to the DLNA system, the photo media file with the mark may be further printed out by a digital media printer of the DLNA system. For most users, the above operating method is inconvenient and troublesome.

Therefore, there is a need of providing a photo media printing method and a photo media printing system using a simplified anti-embezzling process.

### SUMMARY OF THE INVENTION

An object of the present invention provides a photo media printing method using a simplified anti-embezzling process.

Another object of the present invention provides a photo media printing system using a simplified anti-embezzling process.

In accordance with an aspect of the present invention, there is provided a photo media printing method. The photo media printing method includes the following steps. Firstly, a photo thumbnail corresponding to a photo media file is displayed on an electronic device of an area network. In addition, the photo media file and the photo thumbnail are stored in the electronic device. Then, a select command corresponding to the photo media file is received. Then, the photo media file is selected, and a mark is added to the selected photo media file according to the select command, so that a new photo media file containing the mark is produced. Then, a print request corresponding to the new photo media file is transmitted from the electronic device to a network printing device of the area network. According to the print request, the new photo media file is printed out the by the network printing device.

In accordance with another aspect of the present invention, there is provided a photo media printing system. The photo media printing system includes a network router, a digital media player, and a digital media printer. The network router provides a network connection function. The digital media player is connected to the network router through network connection. The digital media player includes a storage element, a display screen, an operation interface, and a controlling unit. The storage element stores a photo media file, a photo thumbnail corresponding to the photo media file and a mark. The display screen is connected to the storage element, and displays the photo media file, the photo thumbnail and the mark. The operation interface receives a select command and a print command corresponding to the photo media file. The controlling unit is connected to the operation interface and the storage element. The controlling unit selects the photo media file according to the select command and adds the mark to the photo media file so as to produce a new photo media file containing the mark is produced, or the controlling unit outputs the new photo media file according to the print command. The digital media printer is connected to the network router through network connection and connected to the digital media player via the network router through network connection, wherein the digital media printer receives the new photo media file and prints out the new photo media file.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

FIG. 2 schematically illustrates the architecture of a second conventional DLNA system;

FIG. 3 schematically illustrates the architecture of a third conventional DLNA system;

FIG. 4 is a schematic functional block diagram illustrating a photo media printing system according to an embodiment of the present invention;

FIG. 5 is a flowchart illustrating a photo media printing method according to an embodiment of the present invention;

FIG. 6 schematically illustrates plural photo media files of the photo media printing system according to the embodiment of the present invention;

FIG. 7 schematically illustrates plural default marks of the photo media printing system according to the embodiment of the present invention; and

FIG. 8 schematically illustrates a new photo media file produced by the photo media printing system according to the embodiment of the present invention.

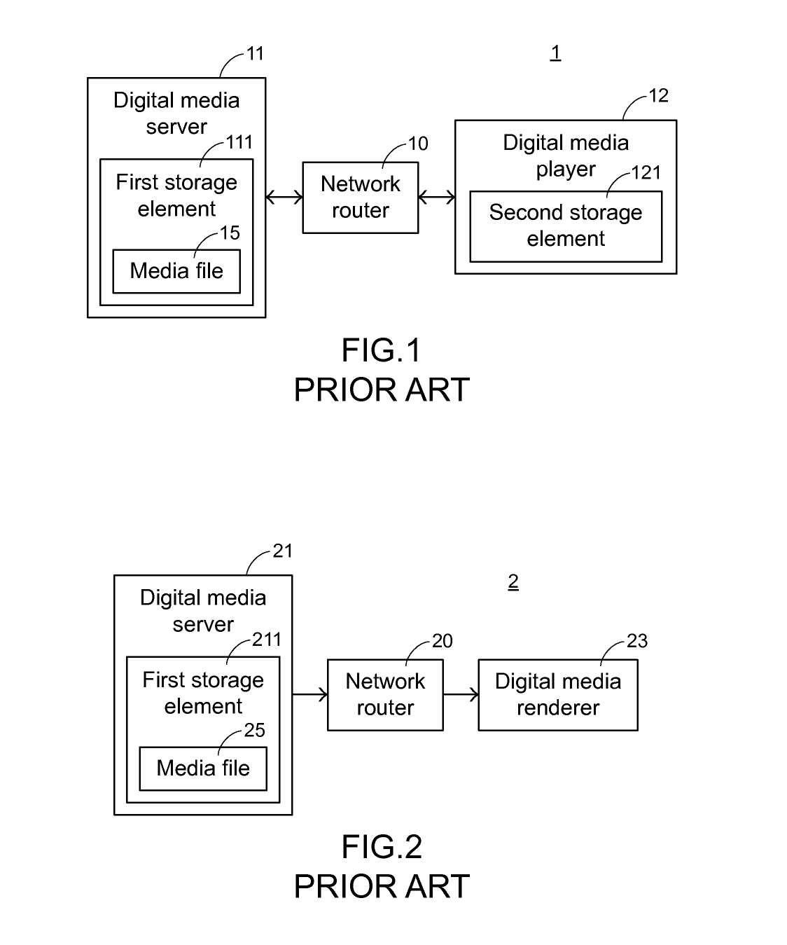

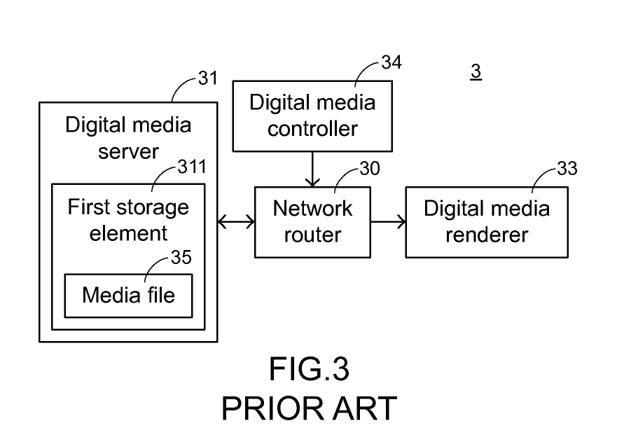

### DETAILED DESCRIPTION OF THE PREFERRED EMBODIMENT

For obviating the drawbacks of the prior art technologies, the present invention provides a photo media printing method for printing photo media files in an area network and a photo media printing system for implementing the photo media printing method of the present invention.

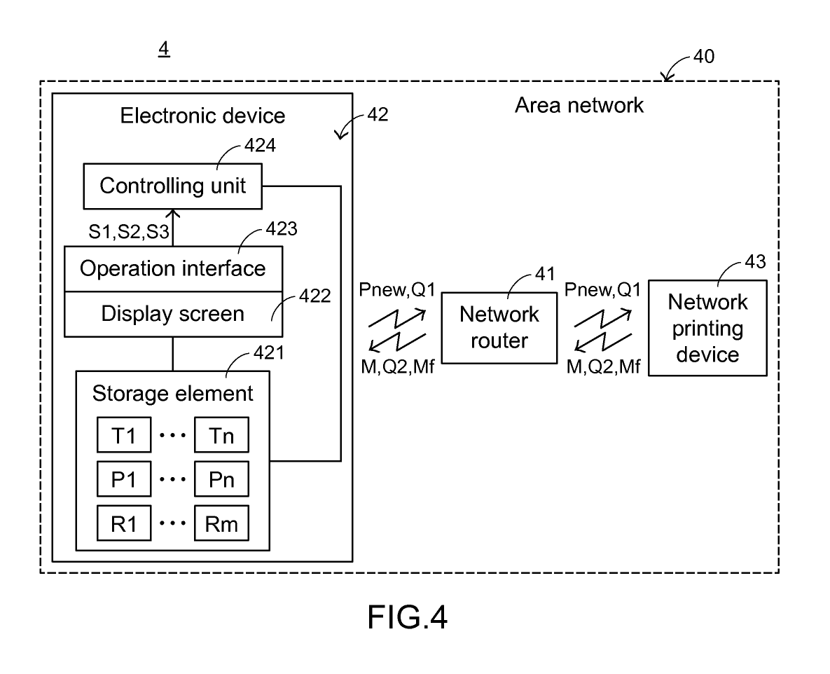

Hereinafter, a photo media printing system of the present invention will be illustrated with reference to FIG. 4. FIG. 4 is a schematic functional block diagram illustrating a photo media printing system according to an embodiment of the present invention. As shown in FIG. 4, the photo media printing system 4 comprises a network router 41, an electronic device 42, and a network printing device 43. The network router 41 is used to provide a network connection function. The electronic device 42 and the network printing device 43 are connected with each other via the network router 41 through network connection. The electronic device 42 is connected to the network router 41 through network connection. Moreover, the electronic device 42 is connected to the network printing device 43 via the network router 41 through network connection. The network printing device 43 is connected to the network router 41 through network connection. Moreover, the network printing device 43 is connected to the electronic device 42 via the network router 41 through network connection. The network printing device 43 may receive a print-ready photo media file and print out the print-ready photo media file. In this embodiment, the network router 41, the electronic device 42 and the network printing device 43 are collaboratively defined as an area network 40. Moreover, the network router 41 complies with the universal plug and play (UPnP) protocol, and both of the electronic device 42 and the network printing device 43 comply with the Digital Living Network Alliance (DLNA) protocol. In this embodiment, the electronic device 42 is digital media player (e.g. a smart phone), and the network printing device 43 is a digital media printer.

As shown in FIG. 4, the electronic device 42 comprises a storage element 421, a display screen 422, an operation interface 423, and a controlling unit 424. The storage element 421 is included in the electronic device 42 for storing plural default marks R1˜Rm, plural photo media files P1˜Pn and plural photo thumbnails T1˜Tn corresponding to the plural photo media files P1˜Pn. The display screen 422 is connected to the storage element 421. The plural default marks R1˜Rm and the plural photo thumbnails T1˜Tn may be displayed on the display screen 422. The operation interface 423 is displayed on the display screen 422 or a surface of the electronic device 42. The user may input a first select command S1, a second select command S2 and a print command S3 via the operation interface 423. The controlling unit 424 is connected to the storage element 421 and the operation interface 423. The controlling unit 424 has two functions. Firstly, the controlling unit 424 may select the corresponding photo media file according to the first select command S 1. Secondly, the controlling unit 424 may add a mark (e.g. a selected default mark) to the selected photo media file according to the print command S3 and acquire a new photo media file containing the mark. In this embodiment, the storage element 421 is a hard disc, the display screen 422 and the operation interface 423 are integrated into a touch screen, and the controlling unit 424 is a microprocessor.

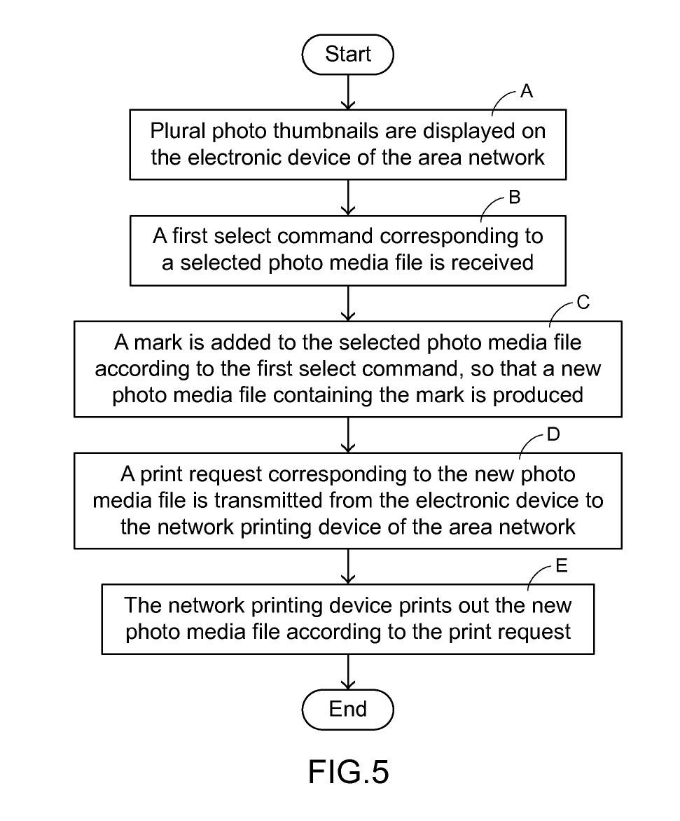

Hereinafter, a photo media printing method according to the present invention will be illustrated with reference to FIG. 5. FIG. 5 is a flowchart illustrating a photo media printing method according to an embodiment of the present invention. The photo media printing method comprises the following steps.

Firstly, in a step A, plural photo thumbnails are displayed on the electronic device of the area network. In a step B, a first select command corresponding to a selected photo media file is received. In a step C, a mark is added to the selected photo media file according to the first select command, so that a new photo media file containing the mark is produced. In a step D, a print request corresponding to the new photo media file is transmitted from the electronic device to the network printing device of the area network. In a step E, the new photo media file is printed out by the network printing device according to the print request.

The step C comprises the following sub-steps C1˜C3. In the sub-step C1, the mark is selected from plural default marks according to a second select command. In the sub-step C2, the mark is superposed on the selected photo media file, so that the new photo media file is produced. In the sub-step C3, the new photo media file is stored into the electronic device.

The step D comprises the following sub-steps D1˜D4. In the sub-step D1, a print command corresponding to the new photo media file is received by the electronic device. In the sub-step D2, the print request corresponding to the new photo media file is transmitted from the electronic device to the network printing device according to the print command. In the sub-step D3, a response message corresponding to the print request is transmitted from the network printing device to the electronic device. In the sub-step D4, a retrieve request corresponding to the new photo media file is transmitted from the network printing device to the electronic device.

The step E comprises the following sub-steps E1˜E3. In the sub-step E1, the new photo media file is transmitted from the electronic device to the network printing device according to the retrieve request corresponding to the new photo media file. In the sub-step E2, the new photo media file is printed out by the network printing device. In the sub-step E3, the new photo media file is deleted from the electronic device.

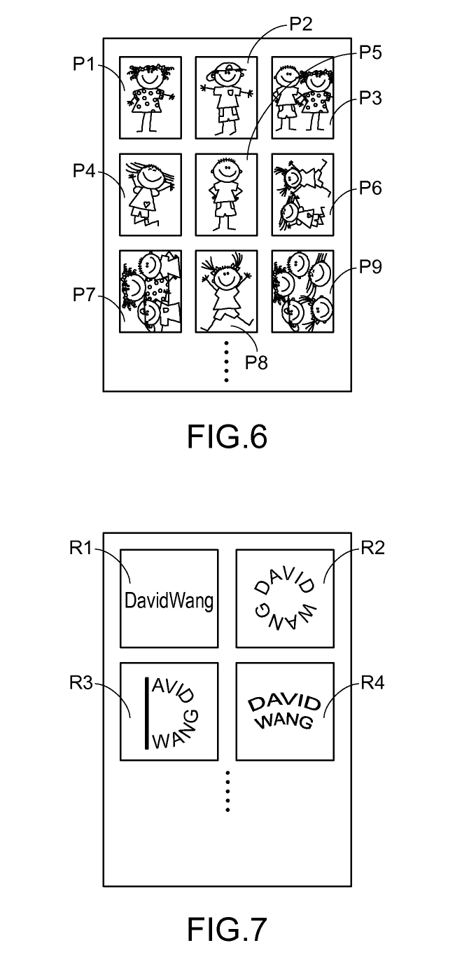

Hereinafter, the detailed procedures of the photo media printing method implemented by the photo media printing system 4 will be illustrated with reference to FIGS. 4˜7. FIG. 6 schematically illustrates plural photo media files of the photo media printing system according to the embodiment of the present invention. FIG. 7 schematically illustrates plural default marks of the photo media printing system according to the embodiment of the present invention.

Firstly, in response to a user's operation via the operation interface 423 of the electronic device 42, plural photo thumbnails T1˜Tn corresponding to plural photo media files P1˜Pn are displayed on the display screen 422 by the controlling unit 424. That is, the step A is performed. Then, in the step B, the user may input a first select command S1 corresponding to the photo thumbnail T5 via the operation interface 423. The first select command S1 corresponds to the photo media file P5. That is, after the user makes a selection by touching the display screen 422 to have the controlling unit 424 receive the first select command S1, the photo media file P5 (see FIG. 5) is selected. In particular, after the user touches the photo thumbnail T5 to generate the first select command S1, the photo media file P5 is selected. Then, plural default marks R1˜Rm stored in the storage element 421 are opened by the controlling unit 424. Consequently, the plural default marks R1˜Rm are displayed on the display screen 422. The examples of some of the plural default marks R1˜Rm are shown in FIG. 7.

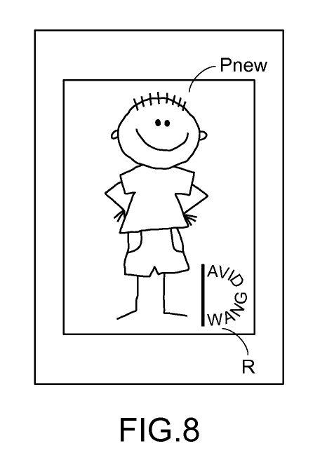

Then, via the operation interface 423, the user may touch the display screen 422 to select the default mark R2 from the plural default marks R1˜Rm. Consequently, a second select command S2 corresponding to the selected default mark R2 is transmitted from the operation interface 423 to the controlling unit 424. That is, the sub-step C1 is performed. Under this circumstance, by the controlling unit 424, the selected default mark R2 is set as the mark R to be added to the photo media file P5. Then, according to the second select command S2, the mark R is superposed on the selected photo media file P5 by the controlling unit 424, so that the new photo media file Pnew is produced. That is, the sub-step C2 is performed. After the new photo media file Pnew is produced, the new photo media file Pnew is stored into the storage element 421. That is, the sub-step C3 is performed. An example of the new photo media file Pnew is shown in FIG. 8. Moreover, the approach of superposing the mark R on the selected photo media file P5 to produce the new photo media file Pnew may be achieved by a watermark generation technology or a stamp mark generation technology. The principles of the watermark generation technology and the stamp mark generation technology are well known to those skilled in the art, and are not redundantly described herein.

Then, via the operation interface 423, the user may touch the display screen 422 to output a print command S3 corresponding to the new photo media file Pnew to the controlling unit 424. That is, the sub-step D1 is performed. According to the print command S3, a print request Q1 corresponding to the new photo media file Pnew is transmitted from the controlling unit 424 to the network printing device 43. That is, the sub-step D2 is performed. Moreover, after the print request Q1 is received by the network printing device 43, a response message M corresponding to the print request Q1 is transmitted from the network printing device 43 to the electronic device 42, and the contents of the print request Q1 are analyzed by the network printing device 43. That is, the sub-step D3 is performed. After the contents of the print request Q1 are completely analyzed by the network printing device 43, according to the analyzing result of the print request Q1, the network printing device 43 may realize that the print-ready photo media file is the photo media file P5. Consequently, a retrieve request Q2 corresponding to the new photo media file Pnew is transmitted from the network printing device 43 to the electronic device 42, and the retrieve request Q2 is received by the electronic device 42. That is, the sub-step D4 is performed.

Then, according to the retrieve request Q2, the new photo media file Pnew is transmitted from the controlling unit 424 of the electronic device 42 to the network printing device 43. That is, the sub-step E1 is performed. After the new photo media file Pnew is received, the new photo media file Pnew is printed out by the network printing device 43 according to the analyzing result of the print request Q1. That is, the sub-step E2 is performed. An example of the new photo media file Pnew is shown in FIG. 8. After the new photo media file Pnew is completely printed out, a print completion message Mf is transmitted from the network printing device 43 to the electronic device 42. According to the print completion message Mf, the controlling unit 424 realizes that the new photo media file Pnew is completely printed out. Under this circumstance, the new photo media file Pnew is deleted from the storage element 421 by the controlling unit 424. That is, the sub-step E3 is performed. Meanwhile, the photo media printing method is completed.

The following two aspects should be specially described. Firstly, after the new photo media file Pnew is deleted from the storage element 421, the storage space of the storage element 421 is not occupied by the new photo media file Pnew, and thus the original storing status of the storage element 421 is maintained. Secondly, the approach of selecting the plural default marks R1˜Rm in the step C is not restricted. For example, there are two variant examples. In a variant example, the manufacturer of the electronic device or the user may set the mark through the controlling unit 424. For example, the default mark R5 may be set as the mark R to be added to the photo media file. After the setting procedure is completed, in the step C, the controlling unit 424 directly adds the default mark R5 to the photo media file in order to produce the new photo media file. In another variant example, the user may operate the operation interface 423 to generate an input data (not shown). According to the contents of the input data, the mark R is created by the controlling unit 424. For example, the input data contains a name information of the electronic device 42 (e.g. David's DMP), an address information of the electronic device 42 (e.g. http://DLNA/David's DMP) or a time information of creating the mark R (e.g. 2014/01/01 PM 03:25). In other words, various approaches may be used to set the mark R.

From the above descriptions, the present invention provides a photo media printing system and a photo media printing method. After a task of adding a mark is performed by a digital media player, a new photo media file with the added mark is produced, then the new photo media file is transmitted to a network printing device, and finally a task of printing the new photo media file is performed. As previously described in the prior art, the mark is manually added to the photo media file, and the new photo media file containing the mark is transmitted to the photo media printing system after the mark is added to the photo media file. That is, the conventional technology is inconvenient and troublesome. According to the photo media printing method of the present invention, the photo media file containing the mark may be printed out by simply selecting the ready-print photo media file and selecting the required mark. In some situations, the step of selecting the required mark may be omitted according to the settings. In comparison with the conventional technology, the photo media printing method of the present invention is simplified without the need of performing complicated operations. Moreover, the photo media printing method of the present invention may additionally produce the new photo media file containing the mark without the need of changing the original photo media file. Consequently, the original storing status of the digital media player is maintained.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A photo media printing method, comprising steps of:
(A) displaying a photo thumbnail corresponding to a photo media file on an electronic device of an area network, wherein the photo media file and the photo thumbnail are stored in the electronic device;
(B) receiving a select command corresponding to the photo media file;
(C) selecting the photo media file and adding a mark to the selected photo media file according to the select command, so that a new photo media file containing the mark is produced;
(D) transmitting a print request corresponding to the new photo media file from the electronic device to a network printing device of the area network; and
(E) printing out the new photo media file by the network printing device according to the print request.

2. The photo media printing method according to claim 1, wherein the step (C) comprises sub-steps of:
(C1) selecting the mark;
(C2) superposing the mark on the selected photo media file, so that the new photo media file is produced; and
(C3) storing the new photo media file into the electronic device, wherein the mark is a default mark previously stored in the electronic device.

3. The photo media printing method according to claim 1, wherein the step (C) comprises sub-steps of:
(C1) allowing the electronic device to receive an input data, so that the mark is created according to the input data;
(C2) superposing the mark on the selected photo media file, so that the new photo media file is produced; and
(C3) storing the new photo media file into the electronic device, wherein the input data comprises a name information of the electronic device, an address information of the electronic device or a time information of creating the mark.

4. The photo media printing method according to claim 1, wherein the step (D) comprises sub-steps of:
(D1) the electronic device receiving a print command corresponding to the new photo media file;
(D2) transmitting the print request corresponding to the new photo media file from the electronic device to the network printing device according to the print command;
(D3) the electronic device receiving a response message corresponding to the print request from the network printing device; and
(D4) the electronic device receiving a retrieve request corresponding to the new photo media file from the network printing device.

5. The photo media printing method according to claim 4, wherein the step (E) comprises sub-steps of:
(E1) transmitting the new photo media file from the electronic device to the network printing device according to the retrieve request corresponding to the new photo media file;
(E2) printing out the new photo media file by the network printing device; and
(E3) deleting the new photo media file from the electronic device after the new photo media file is printed out.

6. The photo media printing method according to claim 1, wherein the electronic device is a digital media player according to a DLNA protocol, and the network printing device is a digital media printer according to the DLNA protocol.

7. A photo media printing system, comprising:
a network router providing a network connection function;
a digital media player connected to the network router through network connection, wherein the digital media player comprises:
a storage element storing a photo media file, a photo thumbnail corresponding to the photo media file and a mark;
a display screen connected to the storage element, and displaying the photo media file, the photo thumbnail and the mark;
an operation interface receiving a select command and a print command corresponding to the photo media file; and
a controlling unit connected to the operation interface and the storage element, wherein the controlling unit selects the photo media file according to the select command and adds the mark to the photo media file so as to produce a new photo media file containing the mark is produced, or the controlling unit outputs the new photo media file according to the print command; and
a digital media printer connected to the network router through network connection and connected to the digital media player via the network router through network connection, wherein the digital media printer receives the new photo media file and prints out the new photo media file.

8. The photo media printing system according to claim 7, wherein plural default marks are stored in the storage element, wherein when the plural default marks are displayed on the display screen and another select command corresponding to the mark is received by the operation interface, the selected default mark is set as the mark to be added to the photo media file by the controlling unit.

9. The photo media printing system according to claim 7, wherein after the new photo media file is produced, a print request corresponding to the new photo media file is transmitted from the controlling unit to the digital media printer, wherein after the print request is received by the digital media printer, a response message is transmitted from the digital media printer to the digital media player, the print request is analyzed by the digital media printer, and a retrieve request corresponding to the new photo media file is transmitted from the digital media printer to the digital media player according to an analyzing result of the print request.

10. The photo media printing system according to claim 9, wherein after the retrieve request is received by the digital media player, the new photo media file is transmitted from the digital media player to the digital media printer, so that the new photo media file is printed out by the digital media printer, wherein after the new photo media file is completely printed out, the new photo media file is deleted from the storage element by the controlling unit.

11. The photo media printing system according to claim 7, wherein the mark is generated according to an input data from the operation interface, wherein the input data comprises a name information of the digital media player, an address information of the digital media player or a time information of creating the mark.
